(19) United States
(12) Patent Application Publication
(10) Pub. No.: US 2012/0043951 A1
(43) Pub. Date: Feb. 23, 2012

(54) Switching Regulator and Constant On-time Module

(76) Inventors: Yueh-Lung Kuo, Taipei County (TW); Chih-Yuan Chen, Hsinchu City (TW)

(21) Appl. No.: 12/982,889

(22) Filed: Dec. 31, 2010

(30) Foreign Application Priority Data
Aug. 23, 2010 (TW) 099128073

(51) Int. Cl. G05F 1/00

(52) U.S. Cl. 323/282

(57) ABSTRACT

The prevent invention provides a switching regulator with a constant on-time structure. The switching regulator includes power stage circuit, for outputting an output voltage to a load according to a control signal, and a constant on-time module, coupled with the power stage circuit, for adjusting off-time of the control signal according to a resistance of the load.

### BACKGROUND OF THE INVENTION

1. Field of the Invention

The present invention relates to a switching regulator and constant on-time module, and more particularly, to a switching regulator and constant on-time module capable of adjusting off-time of a control signal according to a resistance of a load.

2. Description of the Prior Art

Power supply devices play an essential role in modern information technology. Among all the power supply devices, DC-DC switching regulators are very popular and are widely used for providing regulated DC power sources to electronic components. Please refer to FIG. 1, which is a schematic diagram of a DC-DC switching regulator 10 with a constant on-time structure in the prior art. The DC-DC switching regulator 10 provides a steady output voltage Vout1 to a load Ld1 to generate a load current ILd1, and includes an upper gate switch 100, a lower gate switch 102, a constant time trigger circuit 104, a comparator 106, an inductor L1, a capacitor C1, and an inverter INV1. The upper gate switch 100, the lower gate switch 102, the inductor L1 and the capacitor C1 can be seen as a power stage circuit 108, for outputting the output voltage Vout1 to the load Ld1 according to a control signal Con. The constant time trigger circuit 104 can output the control signal Con with each on-time of a constant on-time period Ton to control operations of the upper gate switch 100 and the lower gate switch 102.

In short, when the output voltage Vout1 is less than a reference voltage Vref1, the comparator 106 outputs a comparing result Com, to control the constant time trigger circuit 104 to trigger the outputted control signal Con with an on-time of the on-time period Ton, such that the DC-DC switching regulator 10 can turn on the upper gate switch 100 and turn off the lower gate switch 102 during the on-time period Ton. Thus, an external voltage source Vin1 can deliver electrical energy to the inductor L1 via the upper gate switch 100 to output a charging current IL to charge the capacitor C1, such that the output voltage Vout1, i.e. a voltage across the capacitor C1, is outputted to the load Ld1 increases. When the output voltage Vout1 is greater than the reference voltage Vref1, the upper gate switch 100 is turned off and the lower gate switch 102 is turned on, such that the output voltage Vout1 starts falling. In other words, when the upper gate switch 100 is turned off, the output voltage Vout1 of the DC-DC switching regulator 10 starts falling, and then the upper gate switch 100 is turned on again until the output voltage Vout1 is less than the reference voltage Vref1. As a result, the DC-DC switching regulator 10 can adjust the electrical energy delivered to the load Ld1 by controlling operations of the upper gate switch 100 to provide the steady output voltage Vout1.

Besides, when resistance of the load Ld1 varies, a frequency of the control signal Con being triggered with an on-time of the on-time period Ton varies as well, such that the output voltage Vout1 can be steady. In other words, every time the control signal Con is triggered with an on-time of the on-time period Ton, off-time of the control signal Con is variable, such that the frequency of the control signal Con being triggered with an on-time of the on-time period Ton varies as the resistance of the load Ld1 varies. However, in the prior art, although the frequency of the control signal Con being triggered with an on-time of the on-time period Ton varies as the resistance of the load Ld1 varies, the response is too slow to provide the steady output voltage Vout1.

Please refer to FIG. 2A to FIG. 2F. FIG. 2A to FIG. 2C are schematic diagrams of signals of the DC-DC switching regulator 10 shown in FIG. 1 when the load current ILd1 decreases, i.e. light load or the resistance of the Load Ld1 increases, and FIG. 2D to FIG. 2F are schematic diagrams of signals of the DC-DC switching regulator 10 shown in FIG. 1 when the load current ILd1 increases, i.e. heavy load or the resistance of the Load Ld1 decreases. When the resistance of the load Ld1 remains constant, every time the output voltage Vout1 is less than the reference voltage Vref1, the constant time trigger circuit 104 triggers the control signal Con with an on-time of the on-time period Ton. As a result, the control signal Con can be triggered with an on-time of the on-time period Ton at a constant frequency, to provide the steady output voltage Vout1.

However, as shown in FIG. 2A to FIG. 2C, when the load current ILd1 decreases, the output voltage Vout1 increases due to decrease of the resistance load current ILd1, such that the output voltage Vout1 stays greater than the reference voltage Vref1, and thus the comparing result Com stops the constant time trigger circuit 104 to trigger the control signal Con with an on-time of the constant on-time period Ton, such that the output voltage Vout1 falls to an original steady level. However, in a worst case, i.e. the load current ILd1 decreases just when an on-time of the constant on-time period Ton is triggered, the output voltage Vout1 increases due to decrease of the load current ILd1 as well as the triggered on-time of the on-time period Ton, such that the output voltage Vout1 overshoots, and cannot fall to the original steady level quickly.

On the other hand, as shown in FIG. 2D to FIG. 2F, when the load current ILd1 increases, the output voltage Vout1 decreases due to increase of the load current ILd1, such that the output voltage Vout1 stays lower than the reference voltage Vref1, and thus the comparing result Com keeps indicating the constant time trigger circuit 104 to trigger the control signal Con with an on-time of the on-time period Ton, such that the output voltage Vout1 rises to an original steady level. Since the lower gate switch 102 is required to be turned on to detect overcurrent, every time the control signal Con is triggered with an on-time of the on-time period Ton, an interval of a minimum off-time Tmoff is required in between. However, as shown in FIG. 2D to FIG. 2F, although a frequency of triggering the control signal Con with an on-time of the on-time period Ton increases as the load current ILd1 increases, the output voltage Vout1 can not rise to the original steady level quickly.

In other words, the frequency of the control signal Con being triggered with an on-time of the on-time period Ton can be adjusted when the load current ILd1 varies, such that the steady output voltage Vout1 is provided. However, the response to variation of the load current ILd1 is too slow to provide the steady output voltage Vout1. Thus, there is a need for improvement of the prior art.

### SUMMARY OF THE INVENTION

It is therefore an objective of the present invention to provide a switching regulator and constant on-time module.

The present invention discloses a switching regulator with a constant on-time structure. The switching regulator includes a power stage circuit, for outputting an output voltage to a load according to a control signal; and a constant on-time module, coupled to the power stage circuit, for adjusting off-time of the control signal according to a resistance of the load.

The present invention further discloses a constant on-time module, for adjusting off-time of a control signal according to a resistance of a load. The constant on-time module includes a pulse width modulation (PWM) comparator, for outputting a comparing result according to an output voltage and a reference voltage; a on-time generator, for generating an on-time period according to an input voltage and a comparing voltage; and an off-time adjusting device, for adjusting and outputting off-time of the control signal according to the comparing result, the on-time period and a minimum off-time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a DC-DC switching regulator with a constant on-time structure in the prior art.

FIG. 2A to FIG. 2C are schematic diagrams of signals of the DC-DC switching regulator shown in FIG. 1 when a load current decreases.

FIG. 2D to FIG. 2F are schematic diagrams of signals of the DC-DC switching regulator shown in FIG. 1 when a load current increases.

FIG. 3 is a schematic diagram of a DC-DC switching regulator with constant on-time structure according to an embodiment of the present invention.

FIG. 4 is a schematic diagram of the constant on-time module shown in FIG. 3.

FIG. 5A is a schematic diagram of a reference voltage adjustor shown in FIG. 4.

FIG. 5B is a schematic diagram of a comparing voltage adjustor shown in FIG. 4.

FIG. 5C is a schematic diagram of an on-time generator shown in FIG. 4.

FIG. 6A to FIG. 6C are schematic diagrams of signals of the DC-DC switching regulator shown in FIG. 3 when a load current increases.

FIG. 6D to FIG. 6E are schematic diagrams of signals of the DC-DC switching regulator shown in FIG. 3 optionally including a comparing voltage adjustor shown in FIG. 4 when a load current increases.

FIG. 7 is a schematic diagram of an off-time adjusting device shown in FIG. 4 including a threshold-low comparator circuit.

FIG. 8A to FIG. 8C are schematic diagrams of signals of the DC-DC switching regulator shown in FIG. 3 optionally including the threshold-low comparator circuit shown in FIG. 7 when a resistance of a load increases.

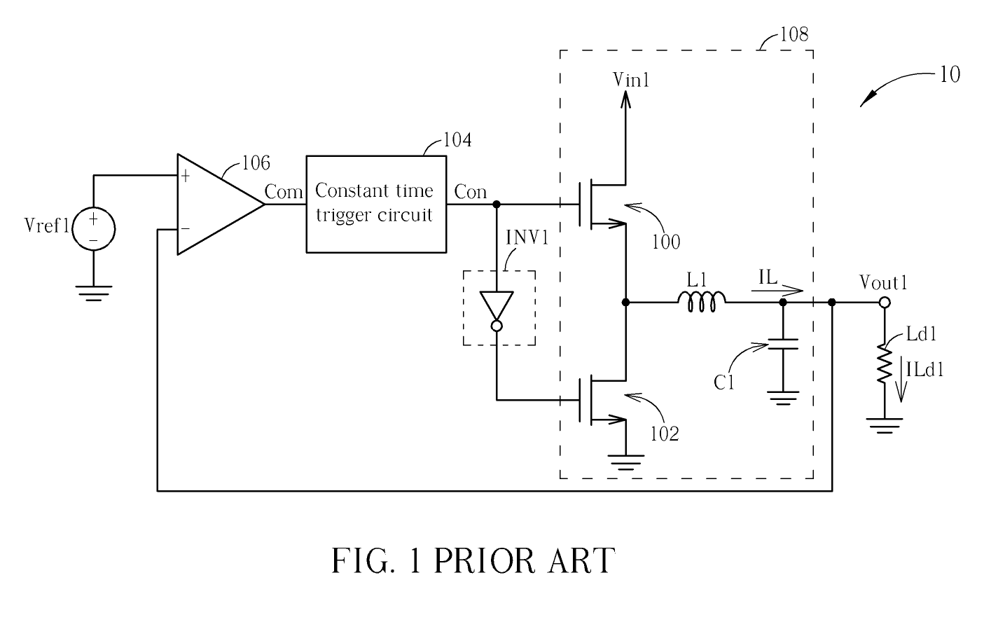

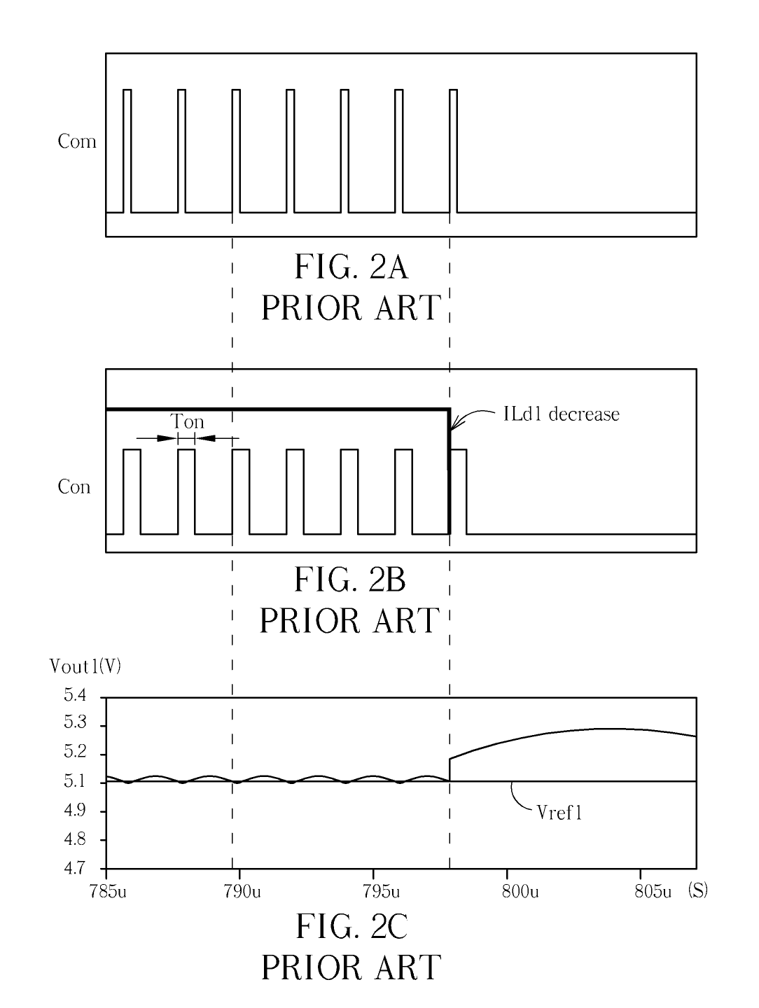

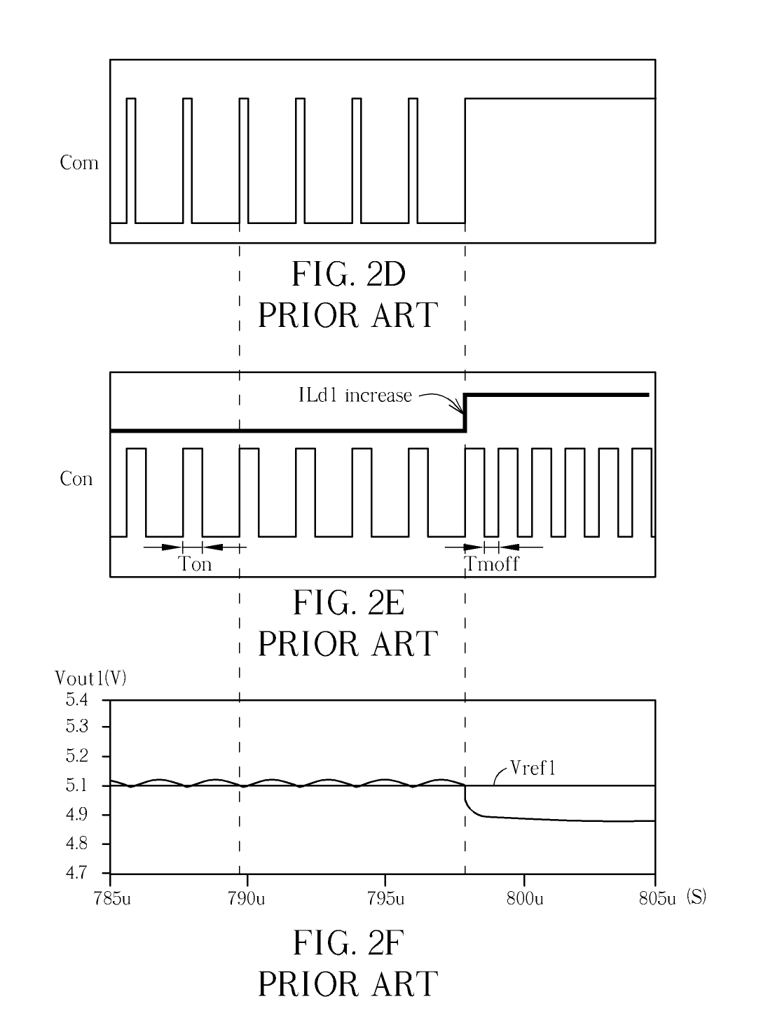

### DETAILED DESCRIPTION

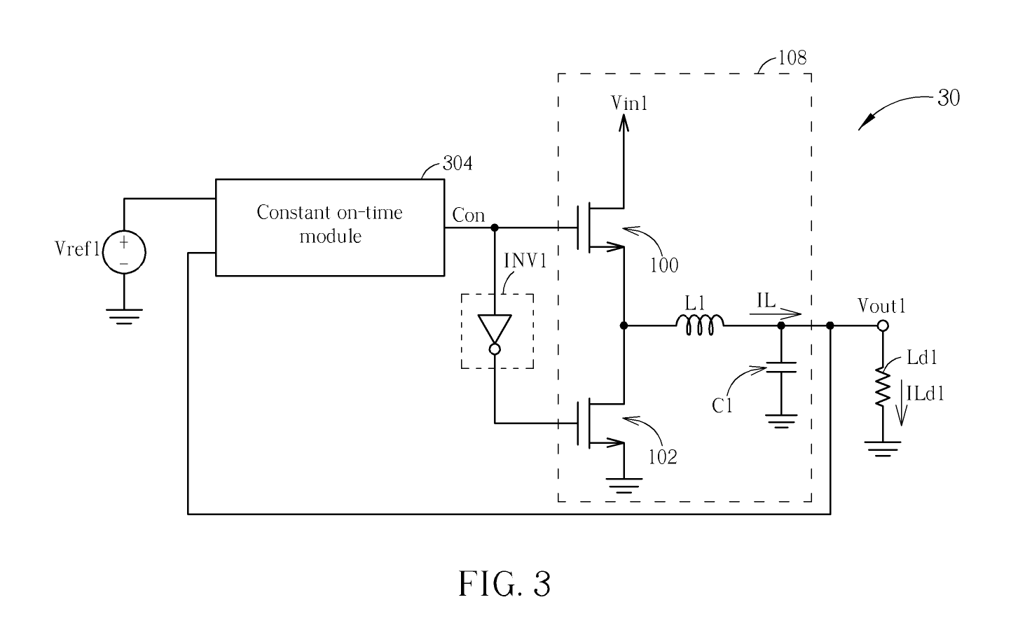

Please refer to FIG. 3, which is a schematic diagram of a DC-DC switching regulator 30 with constant on-time structure according to an embodiment of the present invention. The structure and operating principles of the DC-DC switching regulator 30 are similar to those of the DC-DC switching regulator 10, such that elements and signals with similar functions are denoted with the same symbols for simplicity. Differences between the DC-DC switching regulator 30 and the DC-DC switching regulator 10 are that the DC-DC switching regulator 30 includes a constant on-time (COT) module 304 to replace the constant time trigger circuit 104 and the comparator 106 of the DC-DC switching regulator 10. The constant on-time module 304 adjusts off-time of the control signal Con according to the load current of ILd1 of the load Ld1, i.e. the resistance of the load Ld1.

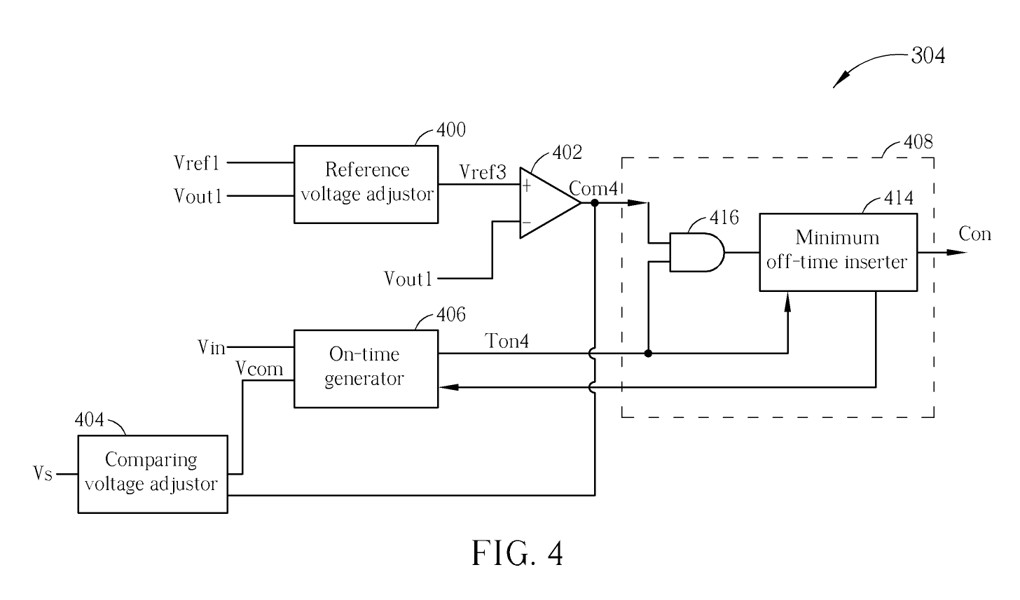

Pease refer to FIG. 4, which is a schematic diagram of the constant on-time module 304 shown in FIG. 3. The constant on-time module 304 includes a reference voltage adjustor 400, a pulse width modulation (PWM) comparator 402, a comparing voltage adjustor 404, an on-time generator 406 and an off-time adjusting device 408. The reference voltage adjustor 400 reduces a reference voltage Vref3 when the output voltage Vout1 rises and increases the reference voltage Vref3 when the output voltage Vout1 falls. The PWM comparator 402 outputs a comparing result Com4 according to the output voltage Vout1 and the reference voltage Vref3. The comparing voltage adjustor 404 adjusts and outputs a comparing voltage Vcom according to the comparing result Com4 and a supply voltage Vs. The on-time generator 406 generates an on-time period Ton4 according to an input voltage VIN and the comparing voltage Vcom, such that the off-time adjusting device 408 adjusts and outputs off-time of the control signal Con. The off-time adjusting device 408 includes an AND gate 416 and a minimum off-time inserter 414. The minimum off-time inserter 414 inserts the minimum off-time Tmoff in the control signal Con to avoid overcurrent.

In short, when the load current ILd1 increases, i.e. heavy load or the resistance of the Load Ld1 decreases, since the comparing result Com4 stays at a high level, the comparing voltage adjustor 404 adjusts the comparing voltage Vcom according to the comparing result Com4 and thus the on-time generator 406 outputs the longer on-time period Ton4. Therefore, the off-time adjusting device 408 can keep triggering the control signal Con with an on-time of the longer on-time period Ton4 and an interval of the minimum off-time Tmoff in between. As a result, the on-time period Ton4 increases as the load current ILd1 increases, so as to reduce off-time of the control signal Con, such that the output voltage Vout1 can rise to an original steady level quickly.

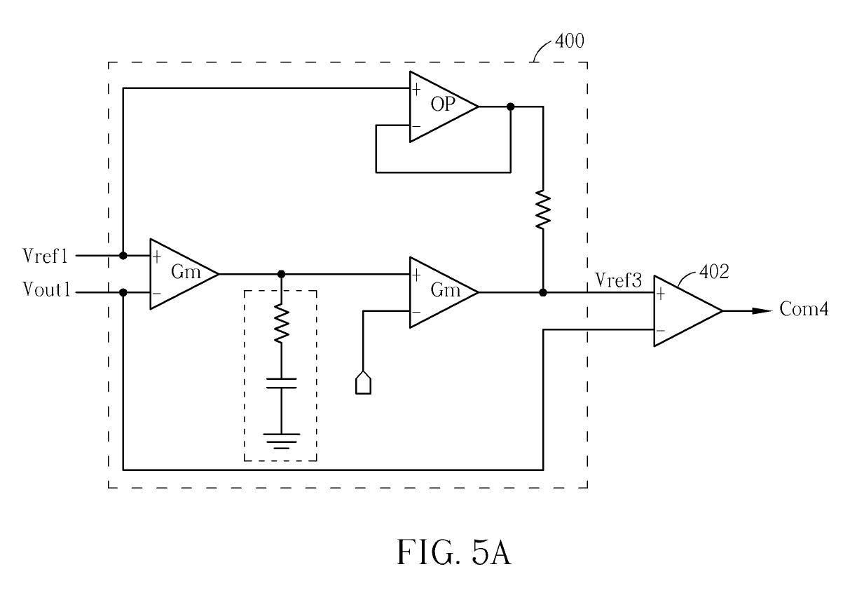

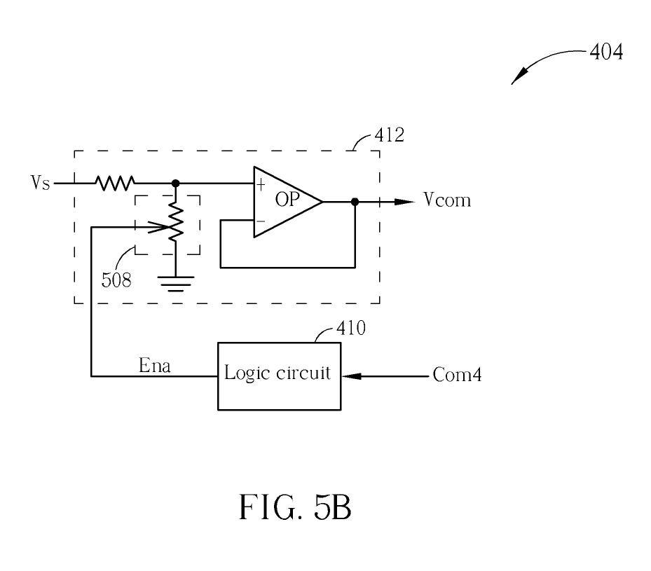

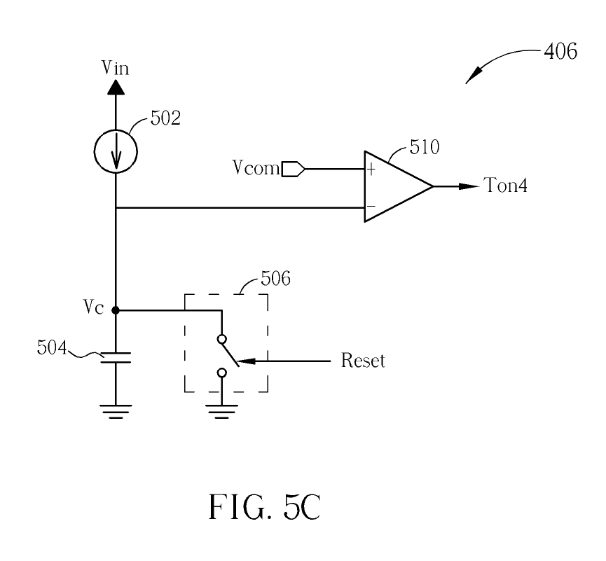

In detail, please refer to FIG. 5A to FIG. 5C. FIG. 5A is a schematic diagram of the reference voltage adjustor 400 shown in FIG. 4, FIG. 5B is a schematic diagram of the comparing voltage adjustor 404 shown in FIG. 4, and FIG. 5C is a schematic diagram of the on-time generator 406 shown in FIG. 4. As shown in FIG. 5A, differences between the PWM comparator 402 and the comparator 106 are that the reference voltage adjustor 400 can adjust the reference voltage Vref3 according to the output voltage Vout1, such that the reference voltage Vref3 decreases when the output voltage Vout1 rises and increases when the output voltage Vout1 falls. Thus, noise margin between the output voltage Vout1 and the reference voltage Vref3 is widened, such that the PWM comparator 402 can perform comparing operations more steadily and correctly.

As shown in FIG. 5B, the comparing voltage adjustor 404 includes a logic circuit 410 and a comparing voltage generator 412. The logic circuit 410 outputs a trigger signal Ena according to the comparing result Com4, and the comparing voltage generator 412 adjusts resistance of a resistor 508 according to the trigger signal Ena, to generate the comparing voltage Vcom.

As shown in FIG. 5C, the on-time generator 406 includes a current source 502, a capacitor 504, a switch 506 and a comparator 510. The current source 502 receives the input voltage VIN to charge the capacitor 504, so as to generate a capacitor voltage Vc to the comparator 510. Thus, the comparator 510 can generate the on-time period Ton4 according to the capacitor voltage Vc and the comparing voltage Vcom. Noticeably, every time after triggering the control signal Con with an on-time of the on-time period Ton4, the off-time adjusting device 408 sends a reset signal Reset to turn on the switch 506 to discharge the capacitor voltage Vc to 0V. Therefore, the on-time period Ton4 outputted by the on-time generator 406 equals a period during which the current source 502 charges the capacitor voltage Vc from 0V to the comparing voltage Vcom. In such a situation, when the load current ILd1 increases, the comparing result Com4 stays at a high level, and thus the logic circuit 410 increases the resistance of the resistor 508 via the trigger signal Ena when a period during which the comparing result Com4 stays at the high level is greater than the original on-time period Ton4, for ensuring the load current ILd1 really increases, so as to increase the comparing voltage Vcom as well as the on-time period Ton4. As a result, the off-time adjusting device 408 can keep triggering the control signal Con with an on-time of the longer on-time period Ton4 and an interval of the minimum off-time Tmoff in between, to reduce off-time of the control signal Con, so as to increase the output voltage Vout1 to the original steady level quickly.

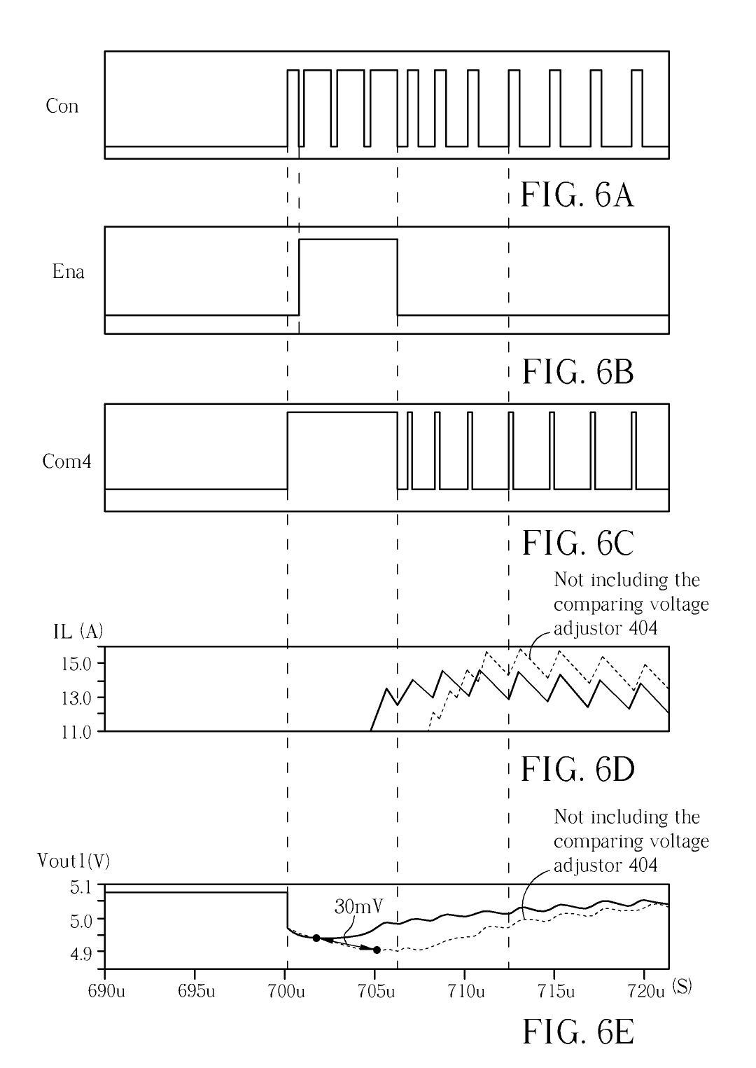

Please refer to FIG. 6A to FIG. 6E. FIG. 6A to FIG. 6C are schematic diagrams of signals of the DC-DC switching regulator 30 shown in FIG. 3 when the load current ILd1 increases, and FIG. 6D to FIG. 6E are schematic diagrams of signals of the DC-DC switching regulator 30 shown in FIG. 3 optionally including the comparing voltage adjustor 404 shown in FIG. 4 when the load current ILd1 increases, wherein solid lines indicate the comparing voltage adjustor 404 is included, and dotted lines indicate the comparing voltage adjustor 404 is not included, where operations are similar to those of the constant on-time period Ton in the prior art. As shown in FIG. 6A to FIG. 6E, when the load current ILd1 increases, since the output voltage Vout1 decreases, the reference voltage Vref3 increases, such that the comparing result Com4 stays at a high level. In such a situation, the trigger signal Ena is switched to a high level to increase the comparing voltage Vcom, so as to increase the on-time period Ton4. Thus, the off-time adjusting device 408 can trigger the control signal Con with an on-time of the longer on-time period Ton4, and an interval of the minimum off-time Tmoff is in between to reduce off-time of the control signal Con, so as to increase the output voltage Vout1 to the original steady level quickly. Compared with the constant on-time period Ton4 shown by the dotted lines, the DC-DC switching regulator 30 including the comparing voltage adjustor 404 can increase the output voltage Vout1 by 30 mV from a lowest level, so as to increase the output voltage Vout1 to the original steady level quickly, and reduce the charging current IL to avoid overcurrent (e.g. 15A).

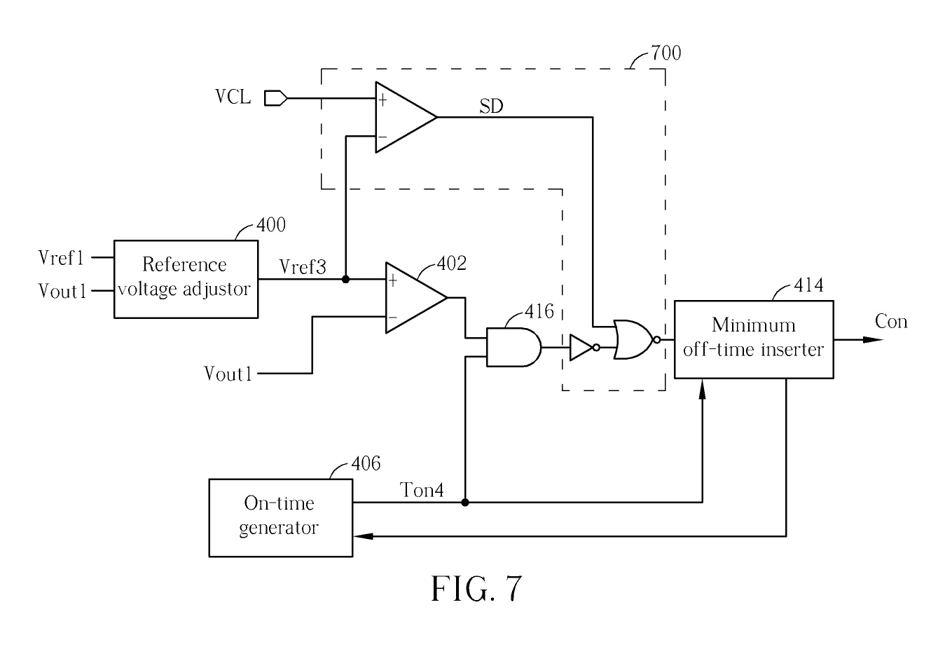

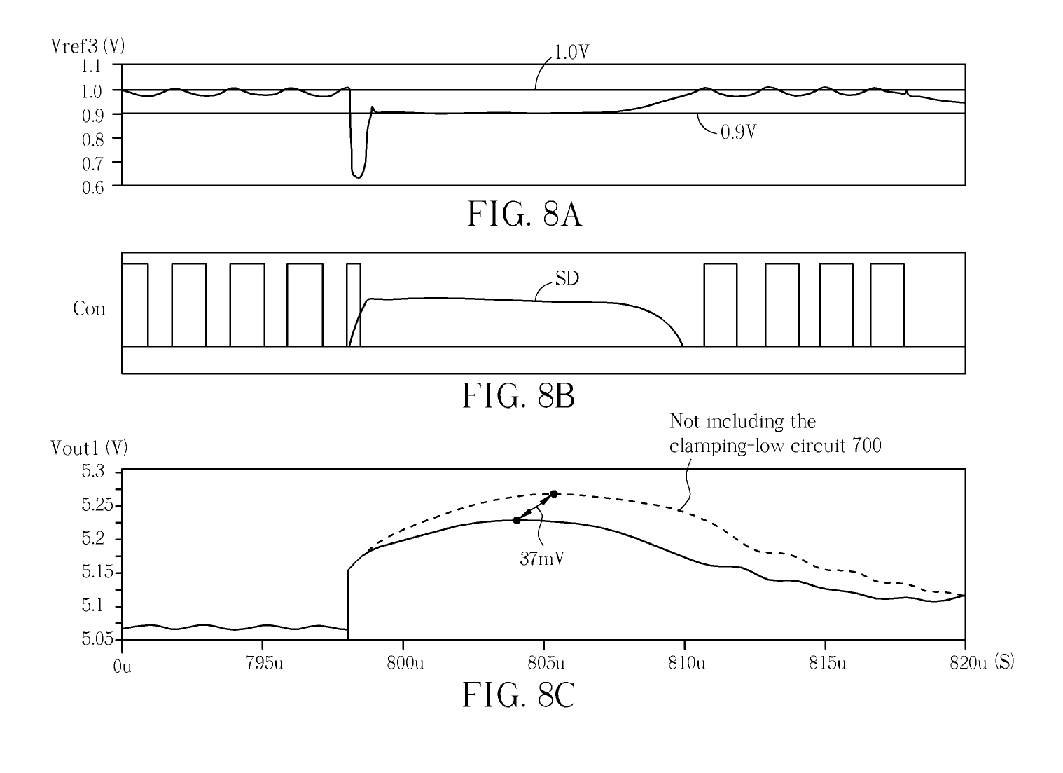

On the other hand, as shown in FIG. 7, the off-time adjusting device 408 can further include a threshold-low comparator circuit 700, for controlling the control signal Con to only include off-time via a shutdown signal SD when the reference voltage Vref3 is less than a threshold-low voltage VCL (e.g. 0.9V), to reduce the output voltage Vout1 to the original steady level quickly when the load current ILd1 decreases, i.e. light load or the resistance of the Load Ld1 increases. In detail, please refer to FIG. 8A to FIG. 8C, which are schematic diagrams of signals of the DC-DC switching regulator 30 shown in FIG. 3 optionally including the threshold-low comparator circuit 700 shown in FIG. 7 when the load current ILd1 increases, wherein a solid line shown in FIG. 8C indicates the threshold-low comparator circuit 700 is included, and a dotted line indicates the threshold-low comparator circuit 700 is not included, where operations are similar to those of the constant on-time period Ton in the prior art. When the load current ILd1 decreases, the output voltage Vout1 increases due to decrease of the load current ILd1, such that the reference voltage adjustor 400 adjusts the reference voltage Vref3 to decrease. In such a situation, when the reference voltage Vref3 is less than the threshold-low voltage VCL, the threshold-low comparator circuit 700 switches the shutdown signal SD to a high level, to control the control signal Con to only include off-time, so as to reduce the output voltage Vout1 to the original steady level quickly. In the prior art, the control signal Con is required to be triggered with an on-time of the whole on-time period Ton, such that the output voltage Vout1 may overshoot. In comparison, the threshold-low comparator circuit 700 can immediately control the control signal Con to only include off-time when the load current ILd1 decreases, so as to reduce the output voltage Vout1 to the original steady level quickly. As a result, as shown in FIG. 8C, the DC-DC switching regulator 30 including the threshold-low comparator circuit 700 can reduce the output voltage Vout1 by 37 mV from a highest level, so as to reduce the output voltage Vout1 to the original steady level quickly.

Noticeably, the spirit of the present invention is that the constant on-time module 304 can adjust off-time of the control signal Con according to, the load current ILd1, i.e. the resistance of the load Ld1. That is, the constant on-time module 304 increases the on-time period Ton4 to reduce off-time of the control signal Con when the load current ILd1 increases while immediately controlling the control signal Con to only include off-time when the load current ILd1 decreases, such that the output voltage Vout1 can recover to the original steady level quickly when the load current ILd1 varies. Those skilled in the art should make modifications or alterations according to the spirit of the present invention. For example, the comparing voltage adjustor 404 is not limited to the above structure as long as the comparing voltage adjustor 404 can increase the on-time period Ton4 to reduce off-time of the control signal Con if a period during which the output voltage Vout1 is greater than the reference voltage Vref3 exceeds the original on-time period Ton4. The threshold-low comparator circuit 700 is also not limited to the above structure as long as the threshold-low comparator circuit 700 can control the control signal Con to only include off-time when the reference voltage Vref3 is less than the threshold-low voltage VCL. Moreover, a method for the trigger signal Ena to increase the resistance of the resistor 508 is to utilize the trigger signal Ena to control conduction of a transistor, to decide whether a portion of the resistor 508 is connected in series to increase resistance.

In addition, the structure of the comparing voltage adjustor 404 is not shown in FIG. 7, which means the constant on-time module 304 can reduce off-time of the control signal Con and increase off-time of the control signal Con via the comparing voltage adjustor 404 and the threshold-low comparator circuit 700, respectively. Those skilled in the art can apply the comparing voltage adjustor 404 and the threshold-low comparator circuit 700 as a whole or separately according to practical requirements to stabilize the output voltage Vout1. Noticeably, when the load current ILd1 increases and the output voltage Vout1 falls, and the on-time period Ton4 is lengthened too much, if the reference voltage Vref3 falls too fast, the comparing result Com4 is switched to a low level, and stops triggering the control signal Con with on-time. At this moment, the output voltage Vout1 keeps pumping the load Ld1 and falls again, which causes the reference voltage Vref3 to rise, such that the comparing result Com4 is switched to a high level, and the control signal Con is triggered with an on-time of the longer on-time period Ton4 again. The above operations repeat until the output voltage Vout1 falls to a lowest level due to increase of the load current ILd1, causing the ripple of the output voltage Vout1 to be too large. To solve the above problem, the on-time period Ton4 is required to be less than a specific value, which avoids the reference voltage Vref3 falling too fast, and avoids the charging current IL being too large. Moreover, when the power stage circuit 108 starts operating from an initial state, the output voltage Vout1 is supposed to rise from a low level to the steady level (e.g. 3V to 5V). At this moment, the comparing voltage adjustor 404 does not operate to avoid the output voltage Vout1 from overshooting and causing too much input energy.

In the prior art, when the load current ILd1 decreases, the triggered on-time of the control signal Con is still equal to the constant on-time period Ton, such that the output voltage Vout1 overshoots and can not reduce to the original steady level quickly; when the load current ILd1 increases, although the frequency of triggering the control signal Con with an on-time of the on-time period Ton increases, the output voltage Vout1 still can not increase to the original steady level quickly. In comparison, the present invention can increase the on-time period Ton4 to reduce off-time of the control signal Con when the load current ILd1 increases, and immediately controls the control signal Con to only include off-time when the load current ILd1 decreases, such that the output voltage Vout1 can recover to the original steady level quickly when the load current ILd1 varies.

To sum up, the present invention can adjusts off-time of the control signal according to the resistance of the load, such that the output voltage can recover to the original steady level quickly.

Those skilled in the art will readily observe that numerous modifications and alterations of the device and method may be made while retaining the teachings of the invention.

What is claimed is:

1. A switching regulator with a constant on-time (COT) structure, comprising:
a power stage circuit, for outputting an output voltage to a load according to a control signal; and
a constant on-time module, coupled to the power stage circuit, for adjusting off-time of the control signal according to a resistance of the load.

2. The switching regulator of claim 1, wherein the power stage circuit comprises:
an upper gate switch, for being turned on during on-time of the control signal;
a lower gate switch, coupled to the upper gate switch, for being turned off during on-time of the control signal;
an inductor, coupled to the upper gate switch and the lower gate switch; and
a capacitor, coupled to the inductor, the output voltage equal to voltage across the capacitor.

3. The switching regulator of claim 2, wherein the upper gate switch and the lower gate switch are metal oxide semiconductor (MOS) transistors.

4. The switching regulator of claim 1, wherein the constant on-time module further comprises:
a pulse width modulation (PWM) comparator, for outputting a comparing result according to the output voltage and a reference voltage;
an on-time generator, for generating an on-time period according to an input voltage and a comparing voltage; and
an off-time adjusting device, for adjusting and outputting off-time of the control signal according to the comparing result, the on-time period and a minimum off-time.

5. The switching regulator of claim 4 further comprising a reference voltage adjustor, for reducing the reference voltage when the output voltage rises and increasing the reference voltage when the output voltage falls.

6. The switching regulator of claim 4, wherein the on-time period is a period during which the comparing voltage is greater than the input voltage.

7. The switching regulator of claim 4, wherein the constant on-time module further comprises a current source, for charging a comparing capacitor, and the input voltage is a voltage across the comparing capacitor.

8. The switching regulator of claim 4, wherein the off-time adjusting device triggers the control signal with an on-time equal to the on-time period when the comparing result indicates the output voltage is less than the reference voltage.

9. The switching regulator of claim 8, wherein the off-time adjusting device triggers the control signal with an interval no less than the minimum off-time between each on-time.

10. The switching regulator of claim 4, wherein the off-time adjusting device reduces off-time of the control signal when a load current of the load increases.

11. The switching regulator of claim 10, wherein the off-time adjusting device further comprises a comparing voltage adjustor, for increasing the comparing voltage when a period during which the comparing result indicates the output voltage is less than the reference voltage exceeds a specific period.

12. The switching regulator of claim 11, wherein the comparing voltage adjustor further comprises:
a logic circuit, for outputting a trigger signal according to the comparing result; and
a comparing voltage generator, for adjusting a resistance according to the trigger signal and a supply voltage, to generate the comparing voltage.

13. The switching regulator of claim 11, wherein the on-time period is less than a specific value.

14. The switching regulator of claim 11, wherein the comparing voltage adjustor does not operate when the power stage circuit starts operating from an initial state.

15. The switching regulator of claim 4, wherein the off-time adjusting device increases off-time of the control signal when a load current of the load decreases.

16. The switching regulator of claim 15, wherein the off-time adjusting device further comprises a threshold-low comparator circuit, for controlling the control signal to only comprise off-time when the reference voltage is less than a threshold-low voltage.

17. A constant on-time (COT) module, for adjusting off-time of a control signal according to a resistance of a load, comprising:
a pulse width modulation (PWM) comparator, for outputting a comparing result according to an output voltage and a reference voltage;
an on-time generator, for generating an on-time period according to an input voltage and a comparing voltage; and
an off-time adjusting device, for adjusting and outputting off-time of the control signal according to the comparing result, the on-time period and a minimum off-time.

18. The constant on-time module of claim 17 further comprising a reference voltage adjustor, for reducing the reference voltage when the output voltage rises and increasing the reference voltage when the output voltage falls.

19. The constant on-time module of claim 17, wherein the on-time period is a period during which the comparing voltage is greater than the input voltage.

20. The constant on-time module of claim 17, wherein the constant on-time module further comprises a current source, for charging a comparing capacitor, and the input voltage is voltage across the comparing capacitor.

21. The constant on-time module of claim 17, wherein the off-time adjusting device triggers the control signal with an on-time equal to the on-time period when the comparing result indicates the output voltage is less than the reference voltage.

22. The constant on-time module of claim 21, wherein the off-time adjusting device triggers the control signal with an interval no less than the minimum off-time between each on-time.

23. The constant on-time module of claim 17, wherein the off-time adjusting device reduces off-time of the control signal when a load current of the load increases.

24. The constant on-time module of claim 23, wherein the off-time adjusting device further comprises a comparing voltage adjustor, for increasing the comparing voltage when a period during which the comparing result indicates the output voltage is less than the reference voltage exceeds a specific period.

25. The constant on-time module of claim 24, wherein the comparing voltage adjustor further comprises:
a logic circuit, for outputting a trigger signal according to the comparing result; and
a comparing voltage generator, for adjusting a resistance according to the trigger signal and a supply voltage, to generate the comparing voltage.

26. The constant on-time module of claim 24, wherein the on-time period is less than a specific value.

27. The constant on-time module of claim 24, wherein the comparing voltage adjustor does not operate when the power stage circuit starts operating from an initial state.

28. The constant on-time module of claim 17, wherein the off-time adjusting device increases off-time of the control signal when a load current of the load decreases.

29. The constant on-time module of claim 28, wherein the off-time adjusting device further comprises a threshold-low comparator circuit, for controlling the control signal to only comprise off-time when the reference voltage is less than a threshold-low voltage.
